(19) United States
(12) Patent Application Publication
(10) Pub. No.: US 2026/0104949 A1
(43) Pub. Date: Apr. 16, 2026

(54) AUTOMATED INSTRUCTION GENERATOR FOR AN AI-POWERED CUSTOMER CHAT SYSTEM

(71) Applicant: Wix.com Ltd., Tel Aviv (IL)

(72) Inventors: Mykhailo ULIANCHENKO, Warsaw (PL); Ady WIERNIK, Kiryat Ono (IL)

(21) Appl. No.: 19/353,638

(22) Filed: Oct. 9, 2025

Related U.S. Application Data
(60) Provisional application No. 63/814,451, filed on May 30, 2025.

(30) Foreign Application Priority Data
Oct. 11, 2024 (UA) A2024 04868

(51) Int. Cl. G06F 9/54

(52) U.S. Cl. CPC G06F 9/543; G06F 9/541

(57) ABSTRACT

A customer chat system facilitates support within an organization. The system features an instruction database, a chat component, and a customer question processor. The instruction database stores instructions and application programming interfaces (APIs). These instructions are structured by a flexible schema, derived from the organization's knowledge base, providing a step-by-step workflow. The chat component engages in conversations with customers, receiving their questions, responses, and comments. The customer question processor then receives the customer input from the chat component and retrieves relevant instructions and APIs from the instruction database. Finally, the chat component follows the retrieved instruction and activates associated APIs during the conversation with the customer. The chat system can synthesize missing APIs from knowledge‑base content or site metadata, reuse prior API analyses indexed by site template, and ingest explicit end‑user feedback to regenerate instructions and associated APIs.

This application claims priority from Ukraine Patent Application No. a 2024 04868, filed October 11, 2024, and from US provisional patent application 63/814,451, filed May 30, 2025, both of which are incorporated herein by reference.

### FIELD OF THE INVENTION

The present invention relates to customer service systems, and more particularly, to customer service systems using automated chat interfaces.

### BACKGROUND OF THE INVENTION

Traditionally, companies employ numerous Customer Service (CS) representatives who follow scripts for specific scenarios. These scripts, often stored in Knowledge Base (KB) articles, include interactive and non-interactive steps, API calls, and internal actions.

Reference is now made to FIG. 1A, which illustrates a prior art automated customer service chatbot interface 10 presenting a menu of options to a customer. These options guide the customer through a series of predefined steps to identify the customer’s issue and provide relevant solutions. This approach, while offering a degree of automation, often leads to customer frustration due to its inflexibility. When frustrated, customers will often request a human service representative (i.e. item 3) instead of continuing to work with the chatbot.

Reference is now made to FIGS. 1B and 1C which, together, show an example prior art customer service bot for a WBS (website building system), such as the WBS of Wix.com, describing how to troubleshoot "connect domain" related problems for a user of the WBS. This customer service bot also has a chatbot interface presenting a menu of possible problems for which the chatbot may provide help. FIG. 1C is a sub-menu of FIG. 1B.

Reference is now made to FIG. 2, which illustrates the prior art process of building a customer service bot's script. The illustration shows a customer 12 who sends a customer service question to a customer service chatbot 14. Chatbot 14 receives a current customer service script from a script database 16, and uses the received script to respond to customer 12. Offline, a customer service agent 20 uses a customer service script editor 18 to create a customer service script which is then stored in script DB 16.

However, writing policies or instructions manually for each task is laborious and time-consuming, especially for large companies with numerous tasks.

### BACKGROUND OF THE INVENTION

There is therefore provided, in accordance with a preferred embodiment of the present invention, a customer chat system for an organization. The system includes an instruction database, a chat component, and a customer question processor. The instruction database stores instructions and associated Application Programming Interfaces (APIs) for addressing customer chat input, where the instructions are structured according to a flexible schema designed from a knowledge base of the organization and organized as a structured prompt, the flexible schema providing a step-by-step description of a workflow. The chat component converses with a customer and receives a current chat input from the customer, where the current chat input includes at least one of: a question, a response and a comment. The customer question processor receives the current chat input from the chat component and retrieves an instruction and associated APIs from the instruction database responding to the current chat input. The chat component also follows the instruction and activates the associated APIs while conversing with the customer.

Moreover, in accordance with a preferred embodiment of the present invention, the customer question processor includes a conversant AI engine.

Further, in accordance with a preferred embodiment of the present invention, the conversant AI engine utilizes one of: retrieval augmented generation (RAG) and model context protocol (MCP) techniques.

Still further, in accordance with a preferred embodiment of the present invention, the flexible schema includes at least one sub-step, a name for each sub-step, per-sub step actions, and conditions to define when to take each action, where each action includes a description, an action type, an action command, and an expected result.

Additionally, in accordance with a preferred embodiment of the present invention, an action type is a wait state for the customer to respond, or a call to one of the associated APIs to provide information.

Moreover, in accordance with a preferred embodiment of the present invention, at least one of the steps, conditions, and actions is divided according to types of customers.

Further, in accordance with a preferred embodiment of the present invention, the knowledge base of the organization includes at least one of customer support articles, scripts, workflows, structured documents, interactive elements, audio, video, recorded interactions between a customer service representative and a customer (written chats or recorded voice/audio chats), and multiple recorded calls or chats related to a same or similar support issue.

Still further, in accordance with a preferred embodiment of the present invention, the system further includes an instruction evaluator-updater that evaluates the instructions based on interactions with the chat component.

Additionally, in accordance with a preferred embodiment of the present invention, the instruction evaluator-updater utilizes statistical analysis to analyze the interactions.

Moreover, in accordance with a preferred embodiment of the present invention, the instruction evaluator-updater ingests end-user feedback signals captured during or after an interaction of the chat component, including one or more of per-turn ratings, per-session ratings, free-text comments, abandonment events, and task-completion confirmations, and to trigger regeneration or revision of at least one of the instructions and the associated APIs based on the feedback signals.

Further, in accordance with a preferred embodiment of the present invention, the system also includes an AI instruction generator that converts documents in the knowledge base into the instructions according to the flexible schema.

Still further, in accordance with a preferred embodiment of the present invention, the system further includes an API synthesis module that, when an action in an instruction lacks a corresponding associated API, (i) infers an operation specification from at least one of documents in the knowledge base and metadata of an underlying system, (ii) generates an API implementing the operation, and (iii) registers the generated API as an associated API for subsequent retrieval by the customer question processor.

Additionally, in accordance with a preferred embodiment of the present invention, the instruction generator receives, from an external site-generation service, (i) prebuilt API specifications or stubs, and (ii) prompt hints or template sections for ingestion into the instruction database.

There is therefore provided, in accordance with a preferred embodiment of the present invention, an instruction generator for converting human-oriented documents (HODs) of an organization into AI agent-adapted instructions. The instruction generator includes an article aggregator, an AI article splitter, and an AI instruction producer. The article aggregator retrieves a set of the HODs on selected topics from a knowledge base of the organization. The AI article splitter divides the retrieved set of HODs into steps, conditions, and actions. The AI instruction producer structures the steps, conditions, and actions into instructions based on a flexible schema that provides a step-by-step description of a workflow, where the structured instructions are stored for retrieval to address customer chat input.

Moreover, in accordance with a preferred embodiment of the present invention, the HODs include at least one of customer support articles, scripts, workflows, structured documents, interactive elements, audio, video, recorded interactions between a customer service representative and a customer (written chats or recorded voice/audio chats), and multiple recorded calls or chats related to a same or similar support issue.

Further, in accordance with a preferred embodiment of the present invention, the generator further includes an AI action query and replacer that reviews the actions and replaces relevant ones of the actions with API calls.

Still further, in accordance with a preferred embodiment of the present invention, the flexible schema includes at least one sub-step, a name for each sub-step, per-sub step actions, and conditions to define when to take each action, where each action includes a description, an action type, an action command, and an expected result.

Additionally, in accordance with a preferred embodiment of the present invention, an action type is a wait state for the customer to respond, or a call to one of the associated APIs to provide information.

Moreover, in accordance with a preferred embodiment of the present invention, at least one of the sub-steps, conditions, and actions is divided according to types of customers.

Further, in accordance with a preferred embodiment of the present invention, the generator further includes an instruction editor that enables customer service representatives to directly edit at least one of the instructions to generate edited instructions.

Still further, in accordance with a preferred embodiment of the present invention, the generator further includes an AI HOD updater that modifies an original HOD associated with at least one of the instructions based on the edited instructions.

Additionally, in accordance with a preferred embodiment of the present invention, the generator further includes an API synthesis module that, when a generated action is identified as a company-related operation without a matching API, infers an operation specification from the retrieved HODs or site metadata, generates an API implementing the operation, and registers the generated API for selection by the AI instruction producer.

Moreover, in accordance with a preferred embodiment of the present invention, the generator further includes a template-indexed repository of prior API analyses and mappings, where at least one of the AI article splitter and the API synthesis module retrieves candidate operations, prompts, or API mappings from the template-indexed repository based on similarity of a target site or document to previously processed sites or templates, and adapts the retrieved items to the target site or document.

There is therefore provided, in accordance with a preferred embodiment of the present invention, a method for providing customer chat support within an organization. The method includes storing instructions and associated Application Programming Interfaces (APIs) for addressing customer chat input in an instruction database, where the instructions are structured according to a flexible schema designed from a knowledge base of the organization and organized as a structured prompt, the flexible schema providing a step-by-step description of a workflow. The method receives a current chat input from a customer via a chat component, where the current chat input includes at least one of: a question, a response, and a comment. The method retrieves an instruction and associated APIs from the instruction database that responds to the current chat input. The chat component follows the retrieved instruction and activates the associated APIs while conversing with the customer.

Further, in accordance with a preferred embodiment of the present invention, the retrieving utilizes one of retrieval augmented generation (RAG) and model context protocol (MCP) techniques.

Still further, in accordance with a preferred embodiment of the present invention, the flexible schema includes at least one sub-step, a name for each sub-step, per-sub step actions, and conditions to define when to take each action, where each action includes a description, an action type, an action command, and an expected result.

Additionally, in accordance with a preferred embodiment of the present invention, an action type is a wait state for the customer to respond or a call to one of the associated APIs to provide information.

Moreover, in accordance with a preferred embodiment of the present invention, at least one of the sub-steps, conditions, and actions is divided according to types of customers.

Further, in accordance with a preferred embodiment of the present invention, the knowledge base of the organization includes at least one of customer support articles, scripts, workflows, structured documents, interactive elements, audio, video, recorded interactions between a customer service representative and a customer (written chats or recorded voice/audio chats), and multiple recorded calls or chats related to a same or similar support issue.

Still further, in accordance with a preferred embodiment of the present invention, the method further includes evaluating the instructions based on interactions with the chat component.

Additionally, in accordance with a preferred embodiment of the present invention, the evaluating utilizes statistical analysis to analyze the interactions.

Moreover, in accordance with a preferred embodiment of the present invention, the method also includes converting documents in the knowledge base into the instructions according to the flexible schema.

There is therefore provided, in accordance with a preferred embodiment of the present invention, a method for generating AI agent-adapted instructions from human-oriented documents (HODs) of an organization. The method includes retrieving a set of the HODs on selected topics from a knowledge base of the organization, dividing the retrieved set of HODs into steps, conditions, and actions, and structuring the steps, conditions, and actions into instructions based on a flexible schema that provides a step-by-step description of a workflow, where the structured instructions are stored for retrieval to address customer chat input.

Further, in accordance with a preferred embodiment of the present invention, the HODs include at least one of: customer support articles, scripts, workflows, structured documents, interactive elements, audio, video, recorded interactions between a customer service representative and a customer (written chats or recorded voice/audio chats), and multiple recorded calls or chats related to a same or similar support issue.

Still further, in accordance with a preferred embodiment of the present invention, the method further includes reviewing the actions and replacing relevant ones of the actions with API calls.

Additionally, in accordance with a preferred embodiment of the present invention, the flexible schema includes at least one sub-step, a name for each sub-step, per-sub step actions, and conditions to define when to take each action, where each action includes a description, an action type, an action command, and an expected result.

Moreover, in accordance with a preferred embodiment of the present invention, an action type is a wait state for the customer to respond or a call to one of the associated APIs to provide information.

Further, in accordance with a preferred embodiment of the present invention, at least one of the sub-steps, conditions, and actions is divided according to types of customers.

Still further, in accordance with a preferred embodiment of the present invention, the method further includes enabling customer service representatives to directly edit at least one of the instructions to generate edited instructions.

Additionally, in accordance with a preferred embodiment of the present invention, the method further includes modifying an original HOD associated with at least one of the instructions based on the edited instructions.

Moreover, in accordance with a preferred embodiment of the present invention, the method further includes, when an action lacks an associated API: inferring an operation specification from at least one of documents in the knowledge base and metadata of an underlying system, generating an API template or wrapper implementing the operation, validating the generated API, and registering the generated API as an associated API for retrieval by a customer question processor.

Further, in accordance with a preferred embodiment of the present invention, the method further includes retrieving, from a repository indexed by site template or by prior site analyses, candidate operations, prompts, or API mappings for reuse, and adapting the retrieved items to a target site or document.

Finally, in accordance with a preferred embodiment of the present invention, the method further includes receiving, from a site-generation service upon creation or update of a site, prebuilt API specifications or stubs and prompt hints for ingestion by an instruction generator, and storing the received items in an instruction database.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a prior art automated customer service chatbot interface presenting a menu of options to a customer;

FIG. 1B is a prior art customer service bot for a WBS (website building system) describing how to troubleshoot "connect domain" related problems for a user of the WBS;

FIG. 1C is a prior art sub-menu of FIG. 1B;

FIG. 2 is a block diagram illustration of a prior art process of building a customer service bot's script;

FIG. 3 is a block diagram illustration of an exemplary AI customer chat system, constructed and operative according to an embodiment of the present invention;

FIG. 4A is a block diagram illustration of a flexible schema, useful in the chat system of FIG. 3;

FIG. 4B is a block diagram illustration of an exemplary instruction produced using the flexible schema of FIG. 4A to replace the chatbot of FIG. 1B;

FIG. 4C is a schematic illustration showing how the system of FIG. 3 responds to a customer's complaint;

FIG. 5A is a block diagram illustration of the elements of a flexible schema-based AI instruction generator forming part of the system of FIG. 3;

FIG. 5B is a block diagram illustration of the elements of an alternative flexible schema-based AI instruction generator, including an API synthesis module and a template-indexed repository for reuse of prior API analyses;

FIG. 6A is a textual illustration of an exemplary implementation of an AI article splitter, forming part of the system of FIG. 3;

FIG. 6B is a textual illustration of an exemplary prompt to a conversant AI engine forming part of the system of FIG. 3;

FIG. 6C is an exemplary troubleshooting article written by a company called “Wix”, for troubleshooting an SSL certificate;

FIGS. 6D-1 and 6D-2 together form an exemplary generated instruction from the article of FIG. 6C;

FIG. 7 is a block diagram illustration of an alternative system using recorded interactions as HODs and including an API synthesis module, a template-indexed repository, and an instruction evaluator-updater that ingests end-user feedback, constructed and operative according to an embodiment of the present invention;

FIG. 8A is a block diagram illustration of components of the API synthesis engine of FIG. 5B; and

FIG. 8B is a flowchart illustration of the method of FIG. 8A.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that a chat session instructed by an AI system may improve the interaction with a customer about a customer service problem such that there is no need for a complicated script. Instead, the resultant chat session may be more flexible to the issues of the customer, continually accessing the relevant company information with each question, comment or response of the customer.

Applicant has realized that the chat session may be further improved by leveraging information that a company produces internally about its products, prices, operation, customer service, etc.

Moreover, Applicant has realized that the chat session may be improved by providing the company information using a flexible schema easily followed by a chat session, especially if the schema helps avoid the hallucinations or incorrect outputs to which current large language models (LLMs) are prone to doing. Moreover, Applicant has realized that further flexibility may be provided by managing different levels of actions, potentially involving multiple Al agents, specialized expert Al assistants, and human customer service (CS) reps, and by accommodating CS assistants at various levels of system use.

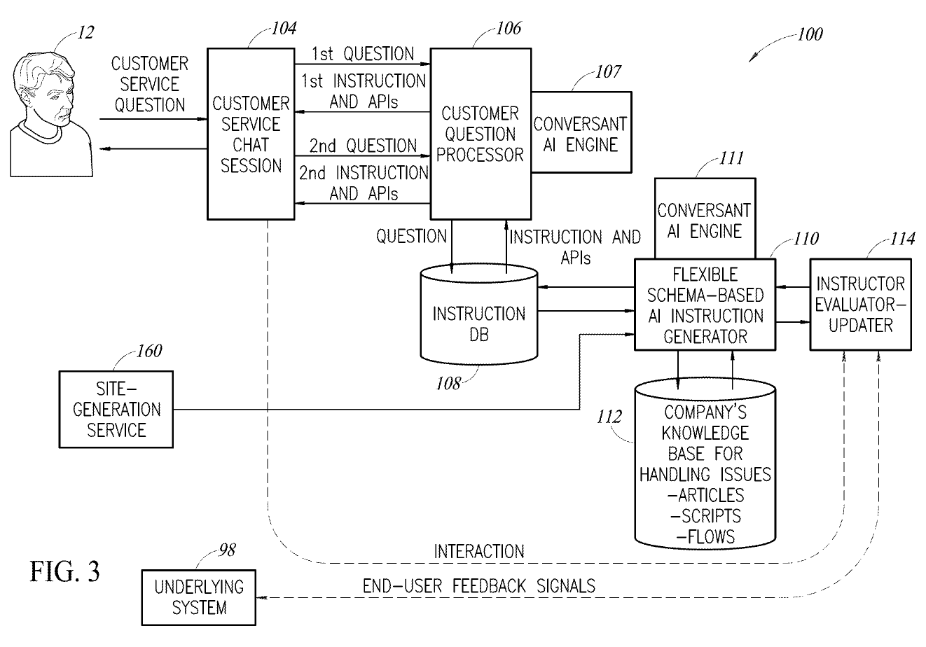

Reference is now made to FIG. 3, which illustrates an exemplary AI customer chat system 100 which may be more flexible than prior art customer service chatbots. Chat system 100 may be based on one or more conversant AI engine, such as a large language model (LLM), like ChatGPT or other large language model, or other type of artificial intelligence capable of conversing with humans.

The system 100 comprises a customer service chat session 104, a customer question processor 106, and an instruction database 108 storing instructions (which may or may not be structured as “prompts”) and associated Application Programming Interfaces (API) calls. System 100 may also comprise a knowledge base 112 of an organization, a flexible schema-based AI instruction generator 110, and an instruction evaluator - updater 114. The organization may be a company, a business, an enterprise, a partnership, or any other organization providing support for a system it operates, and knowledge base 112 may store articles describing how to troubleshoot various issues, and scripts and flows to find and solve such issues. Flexible schema-based AI instruction generator 110 may convert such articles, scripts and flows into easy-to-follow instructions for customer question processor 106, and instruction evaluator - updater 114 may evaluate the instructions based on interactions with chat session 104.

Customer 12 may pose a customer service question, a comment or a response (collectively known as ‘a customer chat input’) to customer service chat session 104, which may be a chat component acting as a mediator to customer question processor 106. Customer service chat session 104 may provide each customer question, comment, or response to customer question processor 106 which, in turn, may parse each customer question to find the relevant pre-prepared instruction(s) and its associated API calls in instruction database 108. The associated API calls may be to data sources or to specific actions related to the company (such as the use of internal systems and utilities), thereby to provide chat session 104 with the ability to utilize internal APIs, to access internal data sources, and to utilize system features while performing the task in the instructions.

Customer question processor 106 may comprise a conversant AI engine 107, which, in an exemplary embodiment, may be an LLM and may be server-based or cloud-based. Customer question processor 106 may be instructed to find at least one set of instructions in instruction database 108 which relate(s) to the customer’s question. Customer question processor 106 may utilize techniques like retrieval augmented generation (RAG) and/or model context protocol (MCP). As is known and discussed in the Wikipedia article, “Retrieval Augmented Generation” (https://en.wikipedia.org/wiki/Retrieval augmented generation), RAG is a framework in AI that enhances generative language models (LLMs) by incorporating information from external sources. It works by first retrieving relevant information from databases, documents, or the web, and then using this information to improve the LLM's ability to generate more accurate, up-to-date, and contextually relevant responses.

As is known and discussed in the Wikipedia article, “Model Context Protocol” (https://en.wikipedia.org/wiki/Model_Context_Protocol), MCP is an open standard that allows AI models, like LLMs, to dynamically access and integrate with external data sources, tools, and other services. It is thus a standardized way for AI models to connect to the real world and to act on information found there.

Question processor 106 may provide the relevant data to chat session 104, which may then follow the instructions and may activate the associated APIs when responding to the customer. It will be appreciated that, in this way, customer service chat session 104 may operate as an automated agent implementing an automated task.

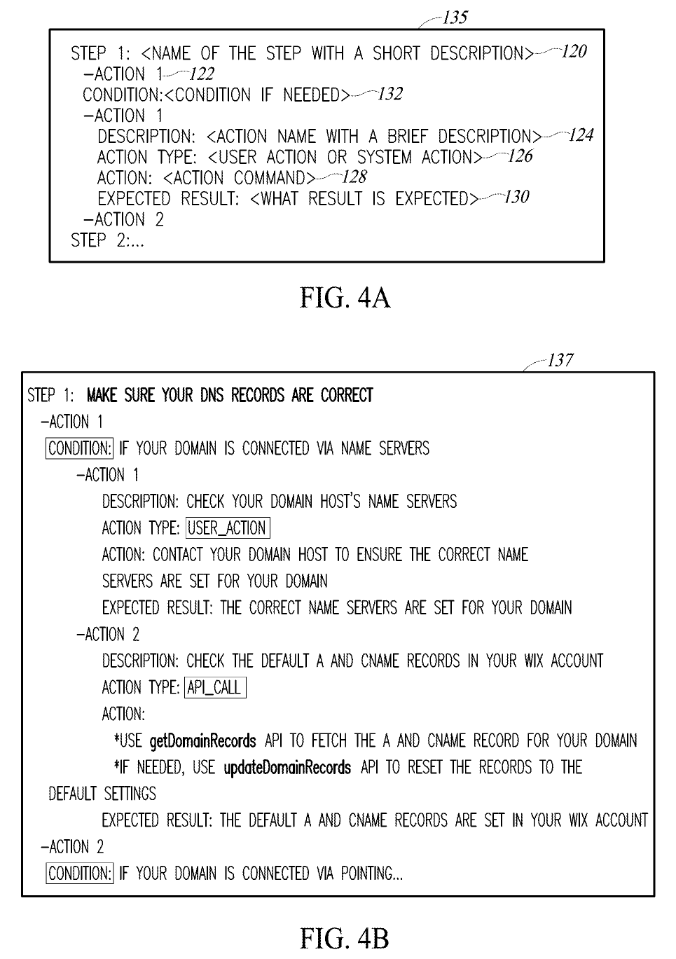

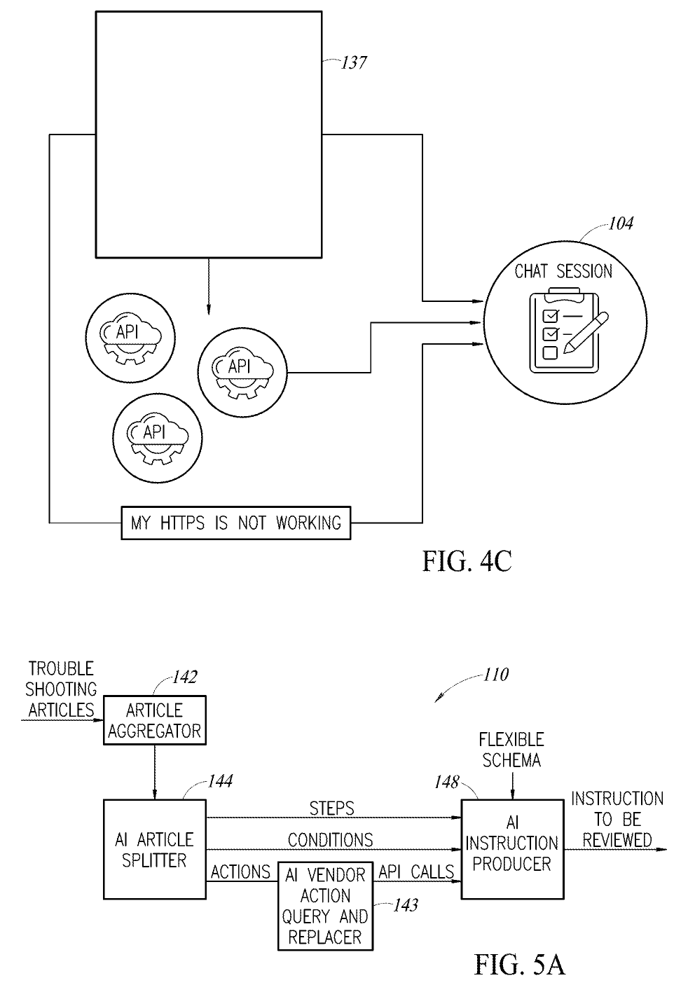

Flexible schema-based AI instruction generator 110 may comprise a conversant AI engine 111, which may be similar to or different from AI engine 107, and may operate offline, such as when prompted by a customer service representative. Generator 110 may pull multiple articles on a selected topic from the company's knowledge base 112 for handling issues. Knowledge base 112 may store articles, scripts, flows, or any other policy content, where policies might be a set of guidelines, rules, or procedures that govern the behavior or actions of individuals or systems. Generator 110 may reorganize the information according to a flexible schema described in FIG. 4A hereinbelow to generate instructions for the instruction database 108. Instruction evaluator - updater 114 may also operate offline, reviewing interactions between the customer and customer service chat session 104 to update the instructions in the instruction database 108 as necessary. Alternatively, or in addition, instruction evaluator - updater 114 may also review end‑user feedback signals, as described hereinbelow, from the company’s underlying system 98, to update the instructions in the instruction database 108.

Conversant AI engine 111 of flexible schema-based AI instruction generator 110 may be trained to work with generator 110 using exemplary data from system 100. For example, entities from knowledge base 112 and a specific schema may be the training input and an associated entity from instruction database 108 may be the training output.

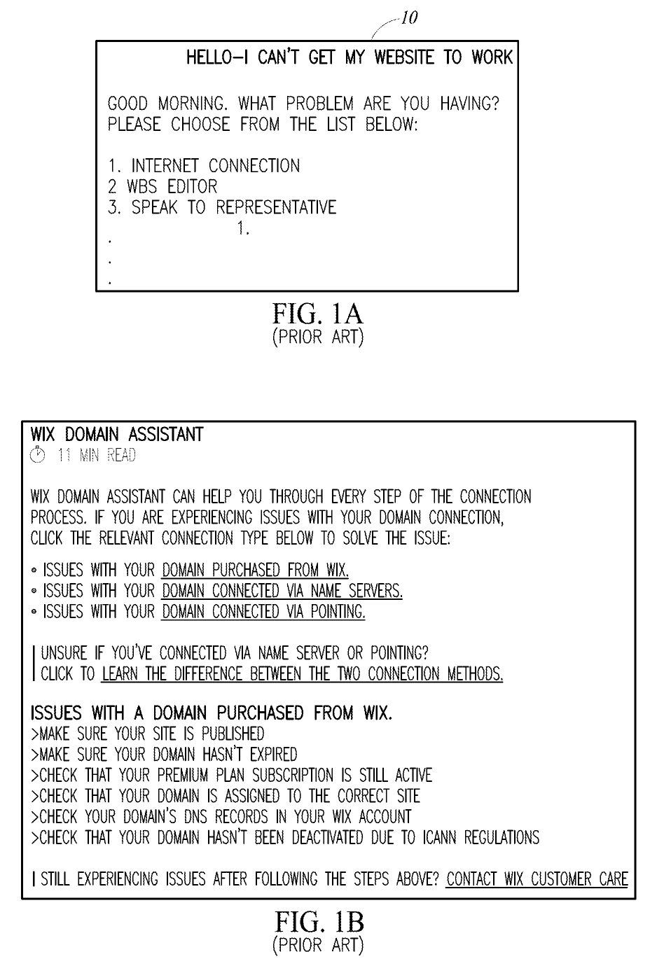

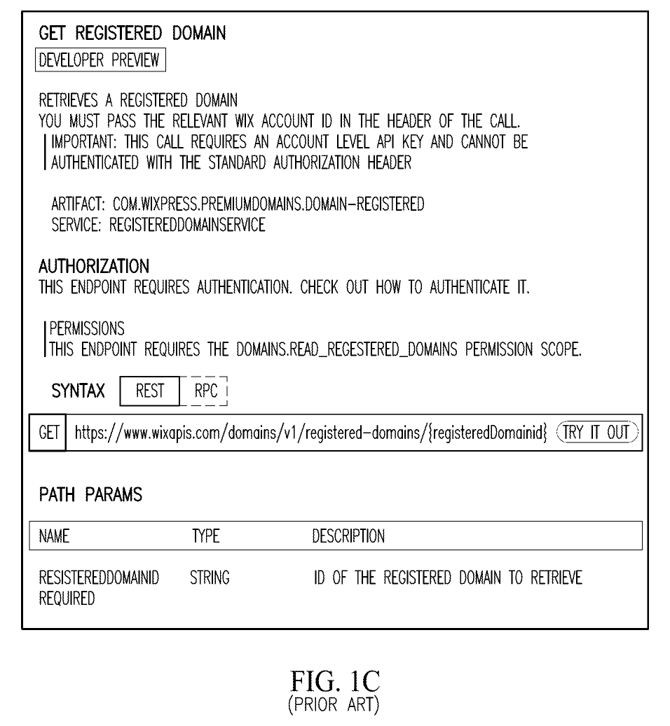

Reference is now made to FIGS. 4A, 4B and 4C. FIG. 4A illustrates a flexible schema 135 and FIG. 4B illustrates an exemplary instruction 137, such as may be produced by instruction generator 112, using flexible schema 135 to replace the troubleshooting “connect domain” chatbot of FIG. 1B. The flexible schema 135 comprises a name 120 for each step, actions 122, which comprise a description 124, an action type 126, an action command 128 and an expected result 130, and conditions 132 to define when to take each action 122. Action type 126 may be either a USER_ACTION, which is a wait state for the user to respond, or an API_CALL, which is a call to a company API to provide information. For example, Step 1 of FIG. 4B is "Make sure your DNS records are correct," and Action 1 includes the condition "If your domain is connected via name servers," with the description "Check your domain host's name servers."

It will be appreciated that flexible schema 135 may provide a step-by-step description of a business flow with an option of nested "sub-steps" actions separated by a condition.

It will be appreciated that the domain chatbot of FIG. 1B has been converted into a step-by-step instruction 137 which uses internal API calls and commands to a user. It will further be appreciated that, during instruction execution, system 100 may provide chat session 104 with the instruction 137. Moreover, instruction 137 may establish the context for chat session 104, such that chat session 104 may only be aware of the task at hand, the step-by-step guidance for completing the task, and the specific tools and interfaces required for that task: This is shown in FIG. 4C. In response to a customer’s complaint that "My https is not working", chat session 104, following instruction 137, retrieves, via customer question processor 106, the relevant instructions and APIs associated with the complaint. Chat session 104 then runs the instructions and activates the APIs as instructed, without adding any further actions.

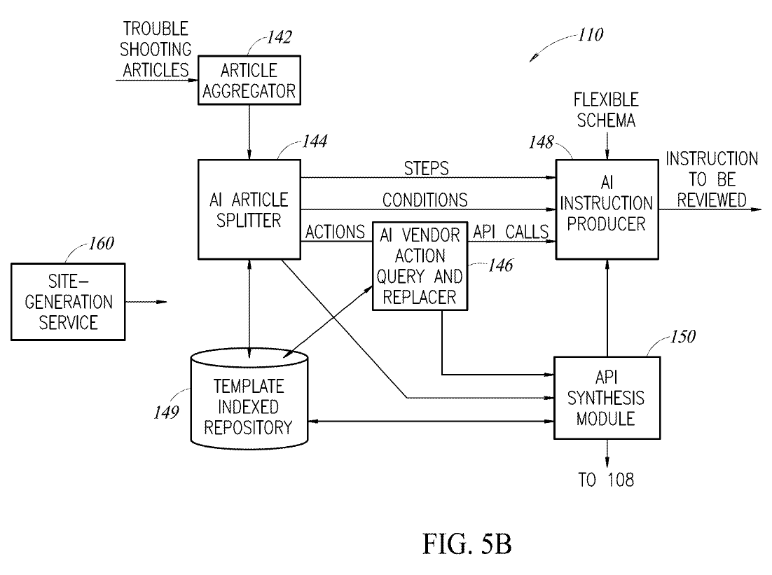

Reference is now made to FIG. 5A , which details the elements of one embodiment of flexible schema-based AI instruction generator 110. The flexible schema-based AI instruction generator 110 comprises an article aggregator 142, an AI article splitter 144, an AI vendor action query and replacer 146, and an AI instruction producer 148.

The article aggregator 142 may obtain a plurality of troubleshooting articles on the selected topic from the company's knowledge base 112. AI article splitter 144 may split the articles into steps, conditions, and actions. AI article splitter 144 may also divide the steps, conditions, and actions according to types of customers (such as, in the case of a WBS, a website designer, a blog creator, a system owner, etc.), to provide “multi-tenancy support”.

To determine API calls which are relevant to the article(s), AI article splitter 144 may search for all related APIs whose description may semantically match the content of the article(s). If, for example, the API calls have platformized API endpoints with textual descriptions, splitter 144 may search for all endpoints whose textual descriptions semantically match the content of the article. For example, Vespa, commercially available at “https://vespa.ai”, may be used as a database with a combined semantic and lexical search through API endpoints.

AI article splitter 144 may also use mitigation strategies to help avoid known types of AI errors. For example, AI article splitter 144 may limit the scope and effect of API calls or actions via a process known as sandboxing. It may also restrict assistant actions to affect only a specific user, may include an ability to reverse actions, as well as requiring human confirmation for irreversible actions. AI article splitter 144 may schedule irreversible actions for background execution, allowing human review and may also use a secondary engine to evaluate actions and check for potential issues.

The AI vendor action query and replacer 146 may review the actions listed by splitter 144 and may determine which actions may be replaced with API calls. To do so, replacer 146 may use semantic similarity between the “action” listed in the generated instruction and an API description.

The AI instruction producer 148 may combine the steps, conditions, API calls and remaining actions together according to the structure of flexible schema.

Reference is now made to FIG. 5B, which illustrates an alternative embodiment of flexible schema-based AI instruction generator 110, which may accelerate construction of instructions and associated APIs across similar sites, in a manner known as “template‑indexed reuse”. For this purpose, instruction generator 110 may maintain a template‑indexed repository 149 having a plurality of site templates, to which may be associated prior API analyses, mappings from action descriptions to API endpoints, prompt hints, and disambiguation notes. During conversion, at least one of AI article splitter 144, API synthesis module 150, and AI vendor action query and replacer 146 may consult repository 149 to retrieve candidate operations or mappings associated with a site template or with a previously analyzed site determined to be similar to the target site by semantic or structural similarity. Herein, “semantic or structural similarity” is computed from one or more of: (i) vector embeddings of API names and descriptions (e.g., using a semantic search engine such as the Vespa search engine); (ii) template and site metadata (entity fields, enabled features, configurations); and (iii) document structure/taxonomy. In one embodiment, repository 149 may be queried by AI article splitter 144, API synthesis module 150, or AI vendor action query and replacer 146 using hybrid lexical and semantic retrieval (possibly applying thresholds), and candidates may be accepted only after conformance checks to the target site. Retrieved candidates may then be verified, adapted to the target site’s configuration, and stored with the new instruction. The adaptation may include (for example) parameter substitution, schema alignment, and policy checks before storage (e.g., based on predefined parameter definitions, schemas, and templates). Note that, in the description hereinabove, the adapting and conforming are to a target website, which is relevant to configurations (contexts) in which underlying system 98 is a website. In other configurations, the adaptation and conforming may be performed against a different, non-website underlying system 98.

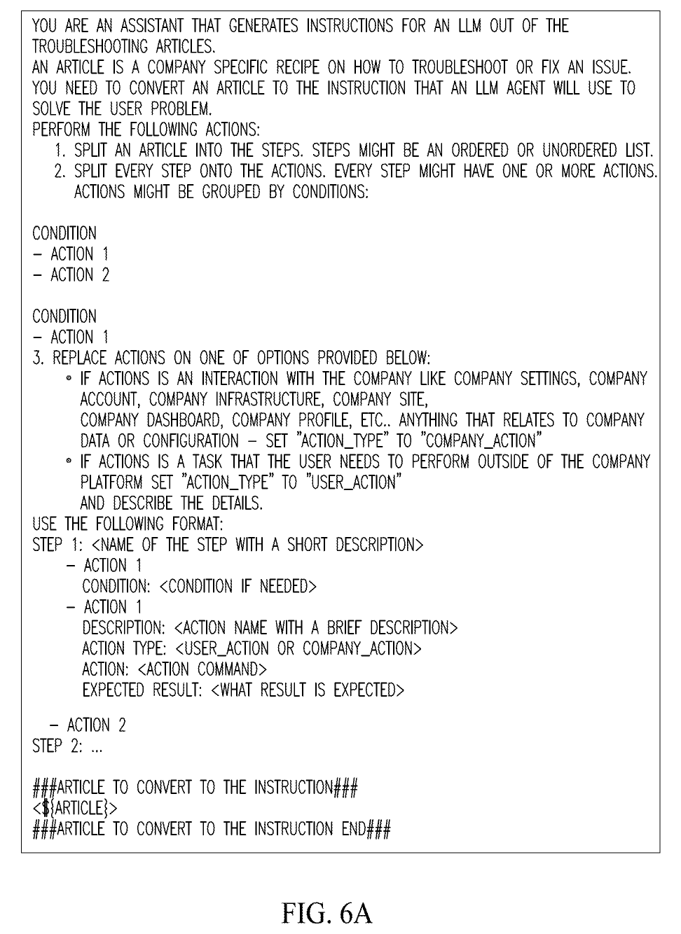

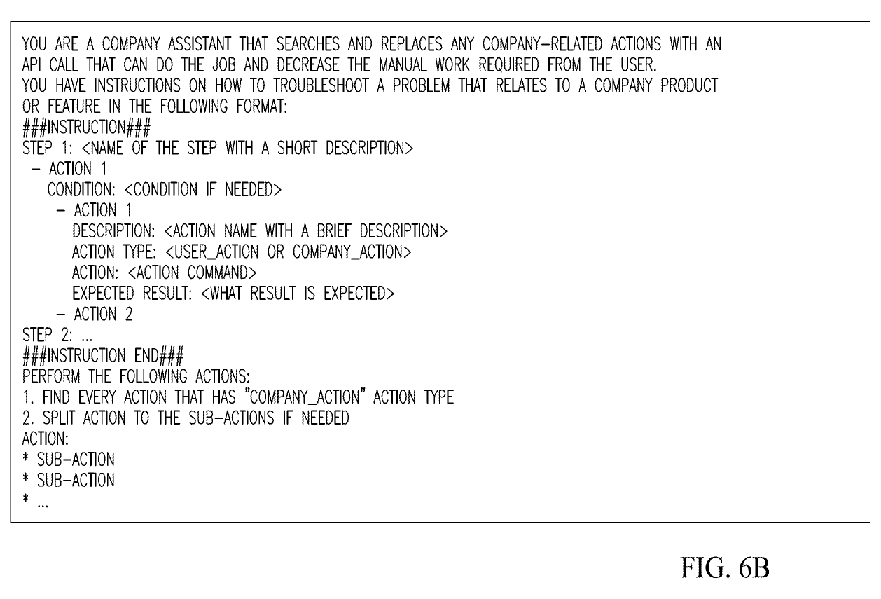

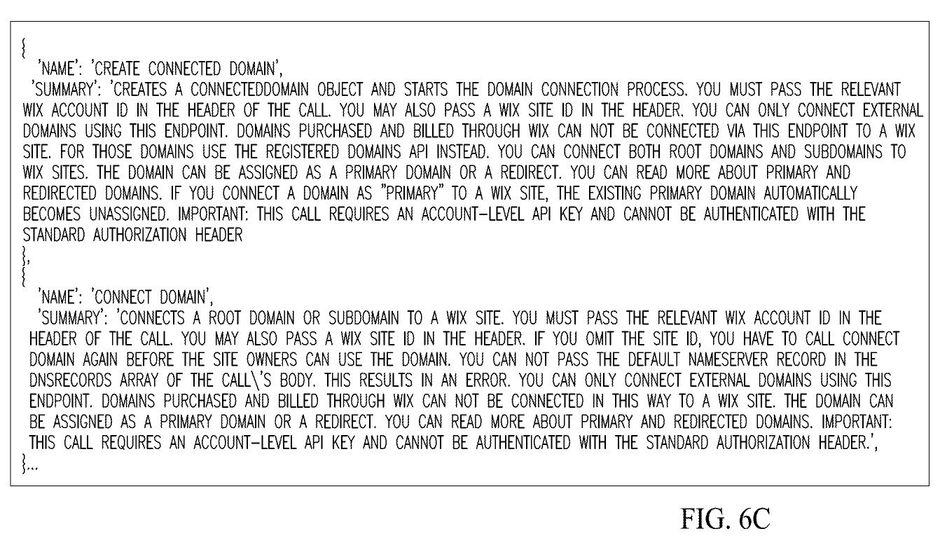

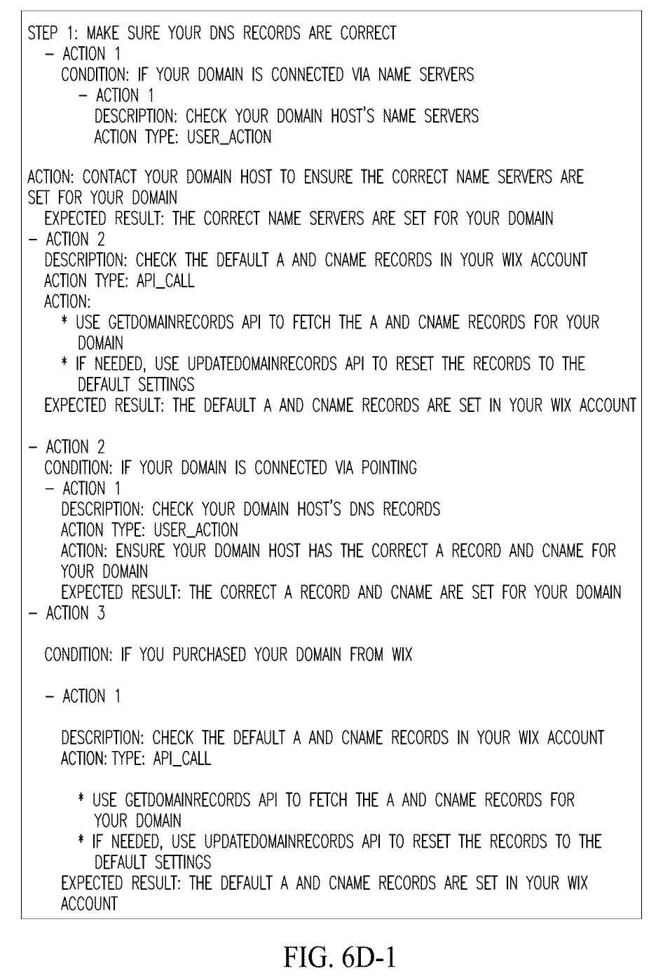

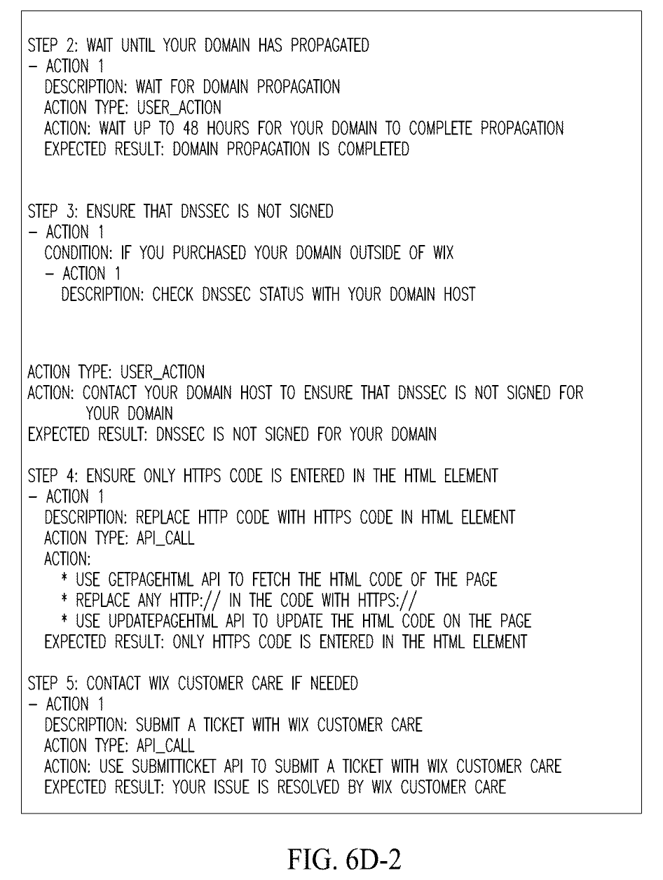

Reference is now made to FIG. 6A, which details an exemplary implementation of AI article splitter 144. The AI article splitter 144 may be implemented with agentic AI and thus, may be implemented as a prompt to conversant AI engine 111, which may be ChatGPT or other LLM and may be server-based or cloud-based. The agentic AI may act as an assistant that generates instructions for customer service chat 104 from troubleshooting articles. As such, article splitter 144 may begin with “You are an assistant that generates instructions for an LLM out of the troubleshooting articles.”

The instructions may specify how to split an article into steps, with each step containing actions that may be grouped by conditions. The instructions may also specify how to replace actions according to one of following options: if the action is an interaction with the company, such as company settings, company account, company infrastructure, company site, company dashboard, company profile, etc., or anything that relates to company data or configurations, set "Action_type" to "COMPANY_ACTION". If the action is a task that a user needs to perform outside of the company platform, set "Action_type" to "USER_ACTION" and detail the action the user is to do. Another type of action may be an “API_CALL”, if such exist in the article being converted. The instructions may also define the format for each step, including a name, actions, conditions, descriptions, action types, action commands, and expected results.

Reference is now made to FIG. 6B, which shows an exemplary prompt to conversant AI engine 111, which may be ChatGPT or other LLM, to implement AI vendor action query and replacer 146. The prompt may instruct the AI vendor action query and replacer 146 to search and replace any company-related actions with an API call that may do the job and may decrease the manual work required from the user. The prompt may receive an instruction and then may perform the following actions: find every action that has “COMPANY_ACTION” action type, may split the action into sub-actions if needed, and if action or sub-action exists in the list of API operations for this article, may replace it with an API call from the list of tools.

When there is no action present, replacer 146 may raise a flag to a customer service representative to generate a new article and/or a new API or to perform some other appropriate action. In the embodiment of FIG. 5B, if no API matches a COMPANY_ACTION, replacer 146 may trigger API synthesis module 150 to infer an operation spec and propose/generate an API, log the gap and raise a review request if required. To provide safeguards to the process, a “human-in-the-loop” approach may be implemented such that, for every article update or creation, and (in particular) for some or all of the API synthesis operations, a review request may be automatically generated. This may be done, for example, through an interface between system 100 and a documentation creation / editing workflow system.

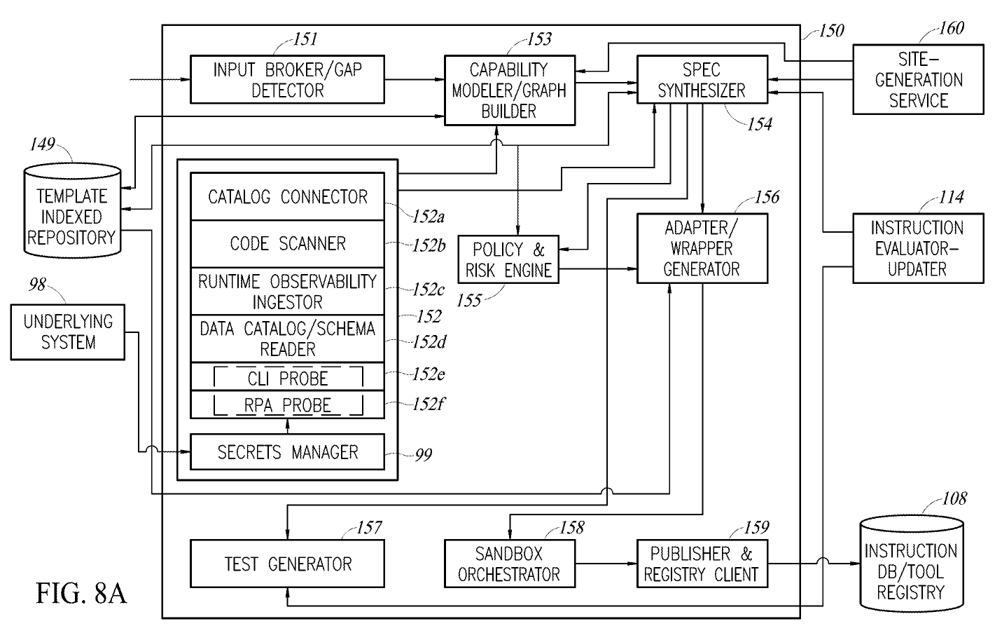

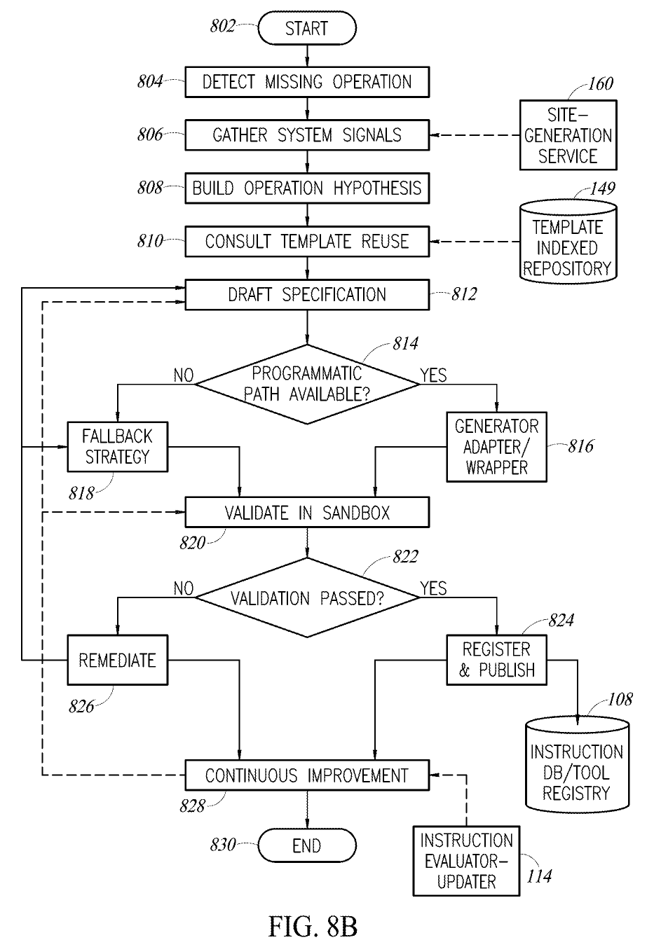

As described in more detail hereinbelow with respect to FIGS. 8A and 8B, API synthesis module 150 may perform some or all of the following steps: (i) infer an operation specification from at least one of: retrieved human oriented documents (HODs), site configuration or template metadata, other system metadata, or other sources; (ii) generate a machine‑readable API specification (e.g., OpenAPI) and an executable wrapper, adapter, or serverless function implementing the operation; (iii) validate the generated API using (for example) sandbox execution and test data; (iv) register the generated API as an associated API; and (v) store the generated API together with the generated instruction in instruction database 108. In this way, generator 110 may reduce or eliminate manual creation of APIs while ensuring that actions formerly listed as “COMPANY_ACTION” become callable APIs in subsequent instruction runs.

API synthesis module 150 may produce a tool description consumable by conversant AI engine 107, and may surface guardrails (argument schemas, preconditions, and expected results) to the evaluator‑updater 114 for policy enforcement and rollback support. The tool description may conform to a machine‑readable schema (e.g., OpenAPI with JSON Schema), and may be registered in a tool registry and/or in instruction database 108 for discovery, security, and policy enforcement.

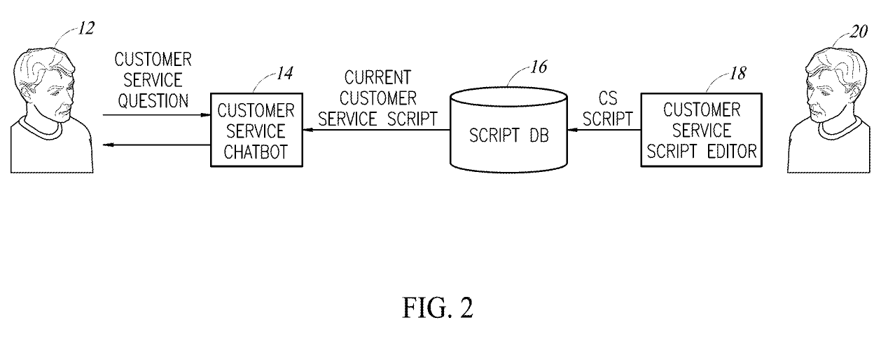

Reference is now made to FIG. 6C, which shows an exemplary troubleshooting article written by a company called “Wix”, for troubleshooting an SSL certificate, that serves as input to the flexible schema-based AI instruction generator 110, to be split into an instruction, and to FIGS. 6D-1 and 6D-2, which together form an exemplary generated instruction from the article of FIG. 6C. The generated instruction includes steps, conditions, and actions. For example, Step 1 of FIG. 6D-1 is "Make sure your DNS records are correct" and includes Action 1 where the condition is "If your domain is connected via name servers," the action type is USER_ACTION and the action is "Contact your domain host to ensure the correct name servers are set for your domain," and the expected result is "The correct name servers are set for your domain". Note that FIG. 6D is a more complete instruction than the one shown in FIG. 6C.

It will be appreciated that, since generator 110 may operate offline, its operation may generate minimal side effects to a customer’s data. As a result, generator 110 may take as much time as needed to generate the large multiplicity of instructions any company may have, and therefore, may execute sequentially.

However, chat session 104, which executes the generated instructions, may need to scale differently, as there may be multiple chat sessions 104 running in parallel. In one embodiment, the number of chat sessions 104 may be scaled according to a classic scaling approach, which may be based on CPU utilization and number of opened requests per service. In this embodiment, from the server's perspective, executing an instruction may be equivalent to an API call. Given that executing such a request can be time-consuming, an alternative scaling method may be auto-balancing, such as by “Round Robin” auto-balancing, of the execution API based on the number of requests handled by each service. An auto-balancing algorithm is a process that automatically adjusts a system to maintain equilibrium or a desired state and the Round Robin algorithm is a scheduling method that distributes resources or tasks to entities (like processes in a CPU or requests in a network) in a cyclical, equal-time fashion. Each entity gets a fixed time slice or quantum before being moved to the end of the queue, ensuring fair access to resources. The Round robin algorithm is described in the Wikipedia article “Round robin scheduling”, found at https://en.wikipedia.org/wiki/ Round-robin_scheduling.

Referring back to FIG. 3, instruction evaluator - updater 114 may utilize statistical analysis to analyze conversations for a given instruction, to determine whether or not they were successful, using a set of metrics or criteria which evaluate the quality and effectiveness of the generated instructions. For example, updater 114 may generate business metrics, such as a Contact Expert’s rate (i.e. how many customers, after interacting with chat session 104, decided to escalate and ask for a human expert) or any other key performance indicator (KPI) for a business that may show how an experience is beneficial for a customer.

Updater 114 may also use offline evaluations of the customer experience. These evaluations may generate the following metrics:

Accuracy - how accurate was the answer in the context of the conversation;

Hallucination rate - how many mistakes, compared with a previously defined ground truth, did chat session 104 make while executing an instruction; and

Thread open rate - how many users after communication with the system decided to open a thread and talk to a human expert.

Updater 114 may also implement these metrics automatically by asking a customer service representative whether the given answer was accurate or hallucinatory, with a note about the opening of any expert threads. Updater 114 may add the conversation with the representative to a final answer, along with all the relevant articles fetched by similarity retrieval and a request to the customer service representative to identify whether the given answer is relevant and correct in relation to the content provided.

Optionally, in addition to business KPIs and customer service representative (CSR) adjudication (i.e. determining how to handle user issues (revolve, escalate, offer rebate, etc.)), evaluator‑updater 114 may ingest explicit end‑user feedback signals captured during or after the chat, e.g., per‑turn or per‑session thumbs up/down, free‑text comments, abandonment or escalation events, and task‑completion confirmations. Signals may be captured by user interface (UI) instrumentation in chat session 104 (e.g., per‑turn/per‑session ratings and comments), by server‑side telemetry in customer question processor 106 (e.g., abandonment, escalation, task completion), by post‑chat surveys, or by biometric user observation mechanisms (motion detection, eye/gaze tracking, biological signal measurement, etc.). Evaluator‑updater 114 may ingest these events via a telemetry pipeline or other APIs or services. Evaluator‑updater 114 may use these signals to (a) trigger regeneration of specific steps or actions within an instruction, (b) request API synthesis module 150 to generate or adjust APIs where repeated negative signals correlate with missing or inadequate automation, and (c) update template‑indexed repository 149 with successful mappings for reuse in similar sites.

Updater 114 may also collect insights on what went wrong (i.e. whether the step was configured in a wrong way or if the API call description did not provide chat session 104 with sufficient clarity on when it can be used). When updater 114 may find an error, it may activate generator 110 to recreate the instruction but to also include in the instruction what mistakes were previously made, in order to make the new instruction be more precise.

It will be appreciated that system 100 may provide several key advantages over existing approaches. It may eliminate the manual bottleneck of hand-crafting instructions for each new use case and may significantly reduce the human effort required to deploy AI agents for new tasks. Moreover, the flexible schema, generated by generator 110 using conversant AI engine 111, may ensure a consistent format and level of detail across all generated instructions. Furthermore, generator 110 may use AI agents to leverage internal tools and capabilities that would be difficult to access through generic instructions.

It will be appreciated that, for the examples provided hereinabove, underlying system 98 is a website building system (WBS), and thus, the APIs and executable actions in the exemplary generated instructions are those of the WBS. System 100 may be used for other types of underlying systems 98, such as to support a general system (e.g., a store, a business, an e-shop, a travel site, etc.), to support website designers as they build their websites within a WBS, and to support end-users as they use websites built by website designers.

Moreover, Applicant has realized that system 100 may be utilized in other types of businesses which handle customer questions, such as a helpdesk or a testing system. Thus, system 100 may be a customer question system instead of or in addition to being a customer service system.

It will be appreciated that system 100, described above, may convert human-oriented documents (HODs), such as the human-written customer support articles, into agent-adapted instructions that are used by support agents, such as chat session 104. In an alternative embodiment, the HODs may not always be just documents; instead, they may also include structure (e.g., document hierarchy), interactivity (e.g., forms, conditional segments), rich media (e.g., audio, video), and other elements.

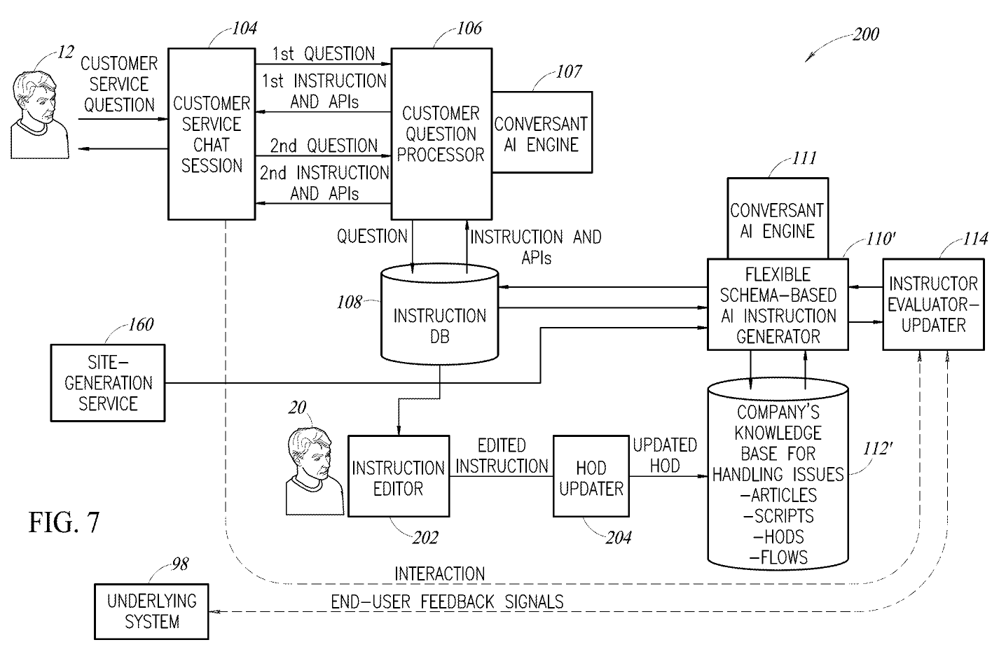

Reference is now made to FIG. 7, which illustrates an alternative system 200 in which the HOD input, stored in an alternative company database, labeled 112’, may not be just written scripts or knowledge base articles. Instead, in system 200, the HODs may be recorded interactions between a customer service representative and a customer, where a recorded interaction may be a written chat or a recorded voice or audio conversation. The HOD(s) may also consist of multiple recorded calls or conversations related to the same or a similar support issue. In this embodiment, the instruction generator, here labeled 110’, may build the instructions based on training on the content of these one or more calls and/or may be trained on manually or programmatically created instructions from instruction database 108.

Alternatively or in addition, the customer service representative may provide input (hints, additional prompts, etc.) from a visual editor to aid API extraction and implementation. For customer service on websites, the WBS templates from which the websites were initially built may comprise hints/prompt sections/etc. to how to generate APIs.

For WBS contexts having an automated site generator, a site‑generation service 160 may, upon creation or update of a site, publish to generator 110 one or more of: (i) API specifications or stubs for site operations; (ii) template‑provided prompt hint sections; and (iii) site‑specific metadata useful for API synthesis and selection. Generator 110 may ingest these items into instruction database 108 and into any tool registry accessible to conversant AI engine 107, thereby reducing conversion latency and improving coverage for site‑specific actions.

System 200 may also comprise an instruction editor 202, allowing customer service representatives to edit the instructions in their native format (which could be a DB, a JSON or XML file, etc.) rather than in a human readable format. In this embodiment, the edited instruction won’t match the original human-oriented document from which it was originally built. To resolve this, system 200 may comprise an HOD updater 204 which may provide AI/LLM-based modification of the original HOD based on the changes to the instruction (including any editing history for both HOD and instruction). System 200 may remove HOD sections and may generate or amend HOD sections to fit the instruction changes while keeping the “tone” and writing style of the rest of the HOD. Such changes may or may not be subject to approval of the relevant customer service representative to ensure the amended HOD is correct and consistent.

Reference is now made to FIG. 8A, which illustrates the components of API synthesis engine 150, and to FIG. 8B, which illustrates the method it implements. When the instruction generator 110 may identify a missing action or COMPANY_ACTION without an associated API, API synthesis module 150 may first collect contextual signals from multiple sources representing the internal structure of underlying system 98. These sources may include service catalogs or registries that describe owned services and their capabilities, configuration data such as deployment manifests, environment variables, and access policies, and source repositories containing controller definitions, route tables, software development kit (SDK) methods, or existing APIs (including their definition, implementation, and documentation). Module 150 may also examine knowledge-base articles, runbooks, or logs that reference commands or workflows related to the desired function. Where available, traces, metrics, and request samples from monitoring systems may reveal existing but undocumented endpoints and typical payload formats. The underlying system 98, other systems, and knowledge base 112 may provide the required (potentially read-only) interface and permissions to do so. The API synthesis engine 150 is activated using this information.

API synthesis engine 150 may analyze knowledge base 112, underlying system 98, as well as other organizations’ systems. Using the aggregated information, the module may construct an operational hypothesis that describes the intent, required inputs, expected outputs, side effects, constraints of the missing action, and handling of errors. The construction of this operational hypothesis may involve a connectors layer harvesting signals from various sources (such as service catalogs and registries; source repositories and configuration artifacts like route tables, controllers, Protobufs, SDKs, gateway policies, etc.); observability systems including traces, logs, and metrics; data catalogs and database schemas; and operator documentation, command line interface (CLI) help, and sandboxed UI flows when available. These heterogeneous artifacts may be normalized into an intermediate representation of entities, relations, capabilities, interfaces, constraints, and observations, and then may be deduplicated and scored for freshness and reliability. Prior analyses in template indexed repository 149 may also be retrieved and adapted.

Based on this, API interface module 150 may infer the structure and behavior of the required operation, and may generate a corresponding API specification and implementation that can be validated and registered for subsequent use by conversational or automation agents. The analysis of underlying system 98 and access to its underlying resources may be made via read‑only or least‑privilege connectors configured by the organization (operators or owners of the underlying system 98), e.g., service catalogs, code repositories (including open-source software used by underlying system 98), observability endpoints, and data catalogs (operating within a security boundary). Note that such API synthesis may constitute a modification or expansion of underlying system 98, creating new functionality which did not exist before.

API synthesis engine 150 comprises an input broker/gap detector 151, a connectors suite 152 (with a catalog connector 152a, a code scanner 152b, a runtime/observability ingestor 152c, a data catalog/schema reader 152d, a CLI probe 152e and a user interface/robotic process automation (UI/RPA) probe 152f), a capability modeler/graph builder 153, a spec synthesizer 154, a policy & risk engine 155, an adapter/wrapper generator 156, a test generator 157, a sandbox orchestrator 158, and a publisher & registry client 159. API synthesis engine 150 may receive data from template indexed repository 149 and site generation service 160, and publisher & registry client 159 may publish its output to instruction DB 108. Evaluator-updater 114 may supply optional feedback.

Input broker/gap detector 151 may receive a “missing action” indication from replacer 146 and may normalize the action intent, scope, and context of the indication for downstream processing. Connector suite 152 may discover system capabilities and evidentiary signals of underlying system 98 via multiple, optionally concurrent, probes 152a – 152f, typically via a secrets manager and/or gateway 99 which may mediate credentials and access to the resources of underlying system 98 for probes 152a – 152f. In addition, secrets manager 99 may also protect underlying system 98 against any issues with generated APIs.

Catalog connector 152a may connect to its service/asset catalogs, code scanner 152b may scan its routers/controllers/protos/SDKs/APIs, runtime/observability ingestor 152c may check its traces/logs/metrics, and data catalog/schema reader 152d may review its database/entity models. Two other probes, CLI probe 152e, which may enumerate permitted commands/flags, and UI/RPA probe 152f, which may probe the user interface and any existing robotic process automation units (such as those described in en.wikipedia.org/wiki/ Robotic_process_automation), may operate in a sandbox and thus, may be enclosed by a security boundary, noted in FIG. 8A with a dashed line.

Capability modeler/graph builder 153 may combine the outputs from connector suite 152 to produce an operation hypothesis identifying target entities, constraints, dependencies, inputs/outputs, and prospective side effects for the missing action. Capability modeler 153 may frame the missing action by parsing the instruction text to determine verb and object, mapping them to a library of capability patterns, resolving the primary entity and the related entities from the instruction text (e.g., – if the instruction was ‘rotate site API key', then the primary entity is “Site”, the related entity is “Key”, and the operation to perform is ”rotate the API key”), and seeding a capability frame with slots for (for example) inputs, outputs, preconditions, postconditions, errors, authorization, idempotency, and rate limits. Capability modeler 153 may use argument inference to fill the frame using (for example) URI templates, handler signatures, data transfer objects, database types and constraints, and observed payload shapes. Capability modeler 153 may reconcile discrepancies conservatively and may propose preconditions, side effects, and postconditions based on guard clauses, feature flags, runbooks, and state deltas observed during a previous sandbox execution. Capability modeler 153 may derive error semantics from code paths, gateway mappings, and operational logs.

Given the operation hypothesis produced by capability modeler 153, spec synthesizer 154 may generate a formal interface description (e.g., OpenAPI, GraphQL SDL, or gRPC proto) defining request/response schemas, error semantics, authorization scopes, rate limits, and explicit preconditions/postconditions.

Policy & risk engine 155 may enforce privilege access, redaction rules, idempotency classes, PII classifications, and tenant scoping, and may annotate the synthesized specification accordingly. Policy and risk engine 155 may also enumerate feasible implementation paths (e.g., REST/GraphQL/gRPC/SDK, then CLI, then sandbox only UI automation). Policy & risk engine 155 may score candidates received from template-indexed repository 149 against the synthesized specification by parameters such as evidence coverage, determinism, safety, testability, and template similarity. The highest scoring candidate, together with its filled capability frame, may constitute the operational hypothesis.

Adapter/wrapper generator 156 may generate an adapter or wrapper implementation of the operational hypothesis in a supported language or framework. The generated code may invoke one or more underlying mechanisms (such as internal REST or gRPC services, other web services, existing SDK calls, and underlying system endpoints, command-line interfaces, or database procedures) to realize the operation described in the specification. The wrapper may automatically incorporate guardrails, including authentication and authorization checks, input validation, idempotency keys, and rate-limit enforcement consistent with organizational policy. The generated code may be an initial version of runnable code of the API (e.g., server handler or function) that orchestrates internal RPC/SDK/HTTP/CLI calls to realize the synthesized operation.

Test generator 157 may derive contract tests, property/fuzz suites, and side effect sentinels from the hypothesis and specification to verify the structure and behavior of the API before publisher & registry client 159 publishes the API. If necessary, secrets manager 99 may mediate credentials and network policy before providing APIs to underlying system 98.

To ensure safety, sandbox orchestrator 158 may initially deploy the generated interface into a sandbox environment containing synthetic or masked data. Test generator 157 may execute automated tests to confirm that (i) request and response structures conform to the specification, (ii) declared preconditions are satisfied, (iii) postconditions hold after execution, and (iv) no unintended side-effects occur. If the validation succeeds, publisher 159 may version-tag the artifact, record associated metadata (owner, permissions, lineage), and publish the specification and endpoint to instruction database or tool registry 108. Where no prior API exists, the validation suite may be generated from the synthesized specification and operation hypothesis using synthetic or masked fixtures and property-based tests; where available, masked production traces may be replayed to verify conformance upon successful validation,

Template indexed repository 149 may supply prior analyses, specifications, mappings, and prompts for reuse and may receive updates arising from successful synthesis. Site generation service 160 may furnish prebuilt API stubs or prompt hints to seed modeling and specification. Evaluator-updater 114 may furnish failure signals and user feedback that may trigger regeneration or revalidation through test generator 150 and spec synthesizer 154.

The API synthesis module 150 may also categorize different API creation requests based on the level of risk associated with the specific APIs. Thus, for example, a read-only API (such as querying or data analysis) may be classified as low risk. In contrast, an API that modifies critical underlying system databases may be classified as high risk (and there could be additional levels between these two risk levels). Policy and risk engine 155 may assign a risk class (e.g., read-only, moderate write, high-risk) from the operation hypothesis, considering side-effects, data categories, and required permissions. This classification occurs before publication and governs test scope, human approval, and rollout gates. The API synthesis module 150 may further utilize this classification to determine the parameters for creating, testing, and deploying the created API – including the type of testing to use, whether to include a human in the loop, and other relevant parameters.

It will be appreciated that, in subsequent conversions, when instruction generator 110 may encounter the same or a similar operation, it may retrieve the newly created API as an associated API, eliminating the need for repeated synthesis. In multi-tenant or template-based deployments, template-indexed repository 149 may store templates and their associated prior analyses and synthesized interfaces, enabling generator 110 to adapt existing specifications to sites that share structural similarities with previously processed templates.

Optionally, site-generation service 160 may supply preliminary API stubs or metadata directly to API synthesis module 150, further reducing inference overhead. Instruction evaluator-updater 114 may also monitor end-user feedback and operational metrics to trigger re-validation or regeneration of synthesized APIs when recurring errors or dissatisfaction signals indicate mismatches between intended and actual behavior.

Through these mechanisms, the automated API synthesis module 150 may enable continuous expansion of callable operations, ensuring that newly identified business actions become programmatically accessible with minimal manual effort while maintaining consistency, safety, and governance across the enterprise system landscape.

FIG. 8B shows a method 800 performed by API synthesis module 150. Input broker/gap detector 151 may broker the gap to detect (step 804) the missing action, connector suite 152 may gather (step 806) evidence of the missing action, and capability modeler 153 may model the capability to build (808) an operation hypothesis. Spec synthesizer 154 may consult (step 810) template reuse, with input from template indexed repository 149, before drafting (step 812) an initial specification to which policy engine 155 may apply security policies.

At step 814, a decision is made. If a programmatic path is available, then adapter generator 156 may generate (step 816) the adapter/wrapper for the API. Otherwise, the method has a fallback strategy in step 818, to use CLI/UI/RPA only, without a wrapper. Either way, the API is validated in a sandbox, in step 820, by test generator 157 and sandbox orchestrator 158.

If the validation is passed, as checked in step 822, publisher 159 may publish the API to tool registry 108. Otherwise, the method may remediate (step 826) and then loop back to steps 812 or 818.

A continuous improvement step 828 may receive feedback from evaluator updater 114 and may loop back to steps 820 or 812, before ending at step 830.

It will be appreciated that alternative embodiments may omit one or more of the elements (e.g., UI/RPA probing) without departing from the scope of engine 150.

Unless specifically stated otherwise, as apparent from the preceding discussions, it is appreciated that, throughout the specification, discussions utilizing terms such as “analyzing,” “generating,” "processing," "computing," "calculating," "determining," or the like, refer to the action and/or processes of a general purpose computer of any type, such as a client/server system, mobile computing devices, smart appliances, cloud computing units or similar electronic computing devices that manipulate and/or transform data within the computing system’s registers and/or memories into other data within the computing system’s memories, registers or other such information storage, transmission or display devices.

The inventive elements discussed hereinabove may be implemented on a suitable apparatus. This apparatus may be specially constructed for the desired purposes, or it may comprise a computing device or system typically having at least one processor and at least one memory, selectively activated or reconfigured by a computer program, code or prompt. The resultant apparatus when instructed by program, code or prompt may turn the general purpose computer into inventive elements as discussed herein. The program, code or prompt may define the inventive device in operation with the computer platform for which it is desired. Such program, code or prompt may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing programs, code or prompts . The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs, code or prompts in accordance with the teachings herein, or it may prove convenient to construct a more specialized apparatus to perform the desired method. The desired structure for a variety of these systems will appear from the description above.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A customer chat system for an organization, the system comprising:
an instruction database configured to store instructions and associated Application Programming Interfaces (APIs) for addressing customer chat input, wherein the instructions are structured according to a flexible schema designed from a knowledge base of said organization and organized as a structured prompt, the flexible schema providing a step-by-step description of a workflow;
a chat component configured to converse with a customer and to receive a current chat input from said customer, wherein said current chat input comprises at least one of: a question, a response and a comment; and
a customer question processor configured to receive said current chat input from said chat component and to retrieve an instruction and associated APIs from said instruction database responding to said current chat input,
said chat component also configured to follow said instruction and to activate said associated APIs while conversing with said customer.

2. The system according to claim 1 wherein said customer question processor comprises a conversant AI engine.

3. The system according to claim 2 wherein said conversant AI engine utilizes one of: retrieval augmented generation (RAG) and model context protocol (MCP) techniques.

4. The system of claim 1, wherein said flexible schema comprises: at least one sub-step, a name for each sub-step, per-sub step actions, and conditions to define when to take each action, wherein each action comprises a description, an action type, an action command, and an expected result.

5. The system of claim 4 wherein an action type is a wait state for said customer to respond, or a call to one of said associated APIs to provide information.

6. The system of claim 4 wherein at least one of said sub-steps, conditions, and actions is divided according to types of customers.

7. The system of claim 1 wherein said knowledge base of said organization comprises at least one of: customer support articles, scripts, workflows, structured documents, interactive elements, audio, video, recorded interactions between a customer service representative and a customer (written chats or recorded voice/audio chats), and multiple recorded calls or chats related to a same or similar support issue.

8. The system of claim 1 further comprising an instruction evaluator-updater to evaluate said instructions based on interactions with said chat component.

9. The system of claim 8 wherein said instruction evaluator-updater utilizes statistical analysis to analyze said interactions.

10. The system of claim 8, wherein the instruction evaluator‑updater ingests end‑user feedback signals captured during or after an interaction of the chat component, including one or more of: per‑turn ratings, per‑session ratings, free‑text comments, abandonment events, and task‑completion confirmations, and to trigger regeneration or revision of at least one of the instructions and the associated APIs based on the feedback signals.

11. The system of claim 1 and also comprising an AI instruction generator to convert documents in said knowledge base into said instructions according to said flexible schema.

12. The system of claim 1, further comprising an API synthesis module configured to, when an action in an instruction lacks a corresponding associated API: (i) infer a specification of an operation from at least one of documents in the knowledge base and metadata of an underlying system, (ii) generate an API implementing the operation, and (iii) register the generated API as an associated API for subsequent retrieval by the customer question processor.

13. The system of claim 11, wherein the AI instruction generator is configured to receive, from an external site‑generation service, (i) prebuilt API specifications or stubs and (ii) prompt hints or template sections for ingestion into the instruction database.

14. An instruction generator for converting human-oriented documents (HODs) of an organization into AI agent-adapted instructions, the instruction generator comprising:
an article aggregator configured to retrieve a set of said HODs on selected topics from a knowledge base of said organization;
an AI article splitter configured to divide said retrieved set of HODs into steps, conditions, and actions; and
an AI instruction producer configured to structure the steps, conditions, and actions into instructions based on a flexible schema that provides a step-by-step description of a workflow, wherein the structured instructions are stored for retrieval to address customer chat input.

15. The generator of claim 14 further comprising an AI action query and replacer configured to review said actions and to replace relevant ones of said actions with API calls.

16. The generator of claim 14 further comprising an instruction editor enabling customer service representatives to directly edit at least one said instructions to generate edited instructions.

17. The generator of claim 16 further comprising an AI HOD updater to modify an original HOD associated with said at least one of said instructions based on said edited instructions.

18. A method for providing customer chat support within an organization, the method including:
storing instructions and associated Application Programming Interfaces (APIs) for addressing customer chat input in an instruction database, where the instructions are structured according to a flexible schema designed from a knowledge base of the organization and organized as a structured prompt, the flexible schema providing a step-by-step description of a workflow;
receiving a current chat input from a customer via a chat component, where the current chat input includes at least one of: a question, a response, and a comment;
retrieving an instruction and associated APIs from the instruction database that respond to the current chat input; and
the chat component following the retrieved instruction and activating the associated APIs while conversing with the customer.

19. A method for generating AI agent-adapted instructions from human-oriented documents (HODs) of an organization, the method including:
retrieving a set of the HODs on selected topics from a knowledge base of the organization;
dividing the retrieved set of HODs into steps, conditions, and actions; and
structuring the steps, conditions, and actions into instructions based on a flexible schema that provides a step-by-step description of a workflow, where the structured instructions are stored for retrieval to address customer chat input.

20. The method of claim 19, further including, when an action lacks an associated API:
inferring a specification of an operation from at least one of documents in the knowledge base and metadata of an underlying system;
generating an API template or wrapper implementing the operation;
validating the generated API; and
registering the generated API as an associated API for retrieval by a customer question processor.

21. The method of claim 19, further including retrieving, from a repository indexed by site template or by prior site analyses, candidate operations, prompts, or API mappings for reuse, and adapting the retrieved items to a target site or document.
